(19) United States
(12) Patent Application Publication
(10) Pub. No.: US 2026/0313761 A1
(43) Pub. Date: Oct. 8, 2026

(54) HOME APPLIANCE

(71) Applicant: LG ELECTRONICS INC., Seoul (KR)

(72) Inventors: Eui Sung KIM, Seoul (KR); Hyunwook MOON, Seoul (KR); Kyungho PARK, Seoul (KR)

(21) Appl. No.: 19/484,562

(22) PCT Filed: Sep. 13, 2024
(86) PCT No.: PCT/KR2024/014085

§ 371 Date: Nov. 14, 2025

(30) Foreign Application Priority Data
Sep. 21, 2023 (KR) 10-2023-0126657
Sep. 21, 2023 (KR) 10-2023-0126658
Sep. 26, 2023 (KR) 10-2023-0129155
Feb. 22, 2024 (KR) 10-2024-0026117
Aug. 13, 2024 (KR) 10-2024-0108514

(51) Int. Cl. H05B 6/12; G01D 5/20; G01D 5/24; H05B 6/06; H05B 6/44

(52) U.S. Cl. CPC H05B 6/1236; G01D 5/20; G01D 5/24; H05B 6/062; H05B 6/44

(57) ABSTRACT

A home appliance is disclosed. This home appliance may comprise a container detection sensor for detecting at least one from among position, size and material of a container placed on a top plate by using an oscillation signal according to the change in equivalent resistance of a plurality of detection coils.

### TECHNICAL FIELD

The present disclosure relates to a home appliance, and more particularly, to a home appliance including an induction heating cooktop.

### BACKGROUND ART

Recently, an induction range using induction heating technology is attracting attention as a next-generation cooking appliance that may replace a gas range due to advantages such as high heating efficiency, fast heating speed, stability, convenience, etc. An induction heating cooktop product includes an induction heating cooktop having a heating coil composed of a ritz wire. When an induction-compatible container is located at a predetermined burner position, the container is heated. This scheme has a disadvantage in that the container should be placed only at a predetermined position, and has a disadvantage in that heating efficiency decreases when the position of the container is slightly incorrect.

Accordingly, all-free induction heating technology is being developed. This is a technology capable of heating the induction-compatible container even when the induction-compatible container is positioned not only at a predetermined area of an induction heating top plate but also at various positions thereof, and has the advantage that various sized containers and a multiple-compartment container having three or more compartments may also be heated.

As a prior art document, European Patent EP 3361827 (2018 Aug. 15) (hereinafter, patent document 1) and U.S. Patent U.S. Pat. No. 11,528,782 (2022 Dec. 13) (hereinafter, patent document 2) is provided.

Patent Document 1 discloses detecting whether a cooking container is disposed on a heating area of a plurality of heating devices using a sensing sensor, but fails to disclose determining a container material that greatly affects operating performance of induction heating. In Patent Document 1, the material of the container is not identified, such that the home appliance has limitations in generating the output desired by an user, or a separate container material sensing means is required.

Patent Document 2 discloses counting output pulses in a predetermined reference count range by applying a single pulse to the heating coil, and determining presence or absence of the cooking container based on this counting result. In Patent Document 2, the container is sensed using the heating coil, so that the home appliance has limitations in detecting the container independently of heating, and in implementing a function such as sensing of displacement of the container position using real-time container sensing. In addition, in Patent Document 2, the container sensing is dependent on the size and position of the heating coil, such that there is a disadvantage in that the degree of freedom of container sensing on the entire cooktop top plate is limited.

### SUMMARY OF DISCLOSURE

### Technical Purpose

A purpose of the present disclosure is to provide a home appliance capable of accurately determining container information for the effect of increasing a degree of positional freedom of the container required for ease of use in an induction heating cooktop, improving power control performance based on container information, and increasing ease of use through the use of an UI/UX.

A purpose of the present disclosure is to provide a home appliance capable of determining the position and size of the container and whether the container is a ferromagnetic container or a paramagnetic container and controlling selection of a heating coil to be driven and an intensity of power to be applied to the selected heating coil, based on the determining result in an induction heating cooktop.

A purpose of the present disclosure is to provide a home appliance capable of simplifying a system based on an integrated structure of a heating coil and a sensing coil using a printed circuit head (PCB) pattern coil.

A purpose of the present disclosure is to provide a home appliance capable of determining the position and the size of a container and the material of the container by applying at least two container sensing schemes in an PCB pattern coil structure.

A purpose of the present disclosure is to provide a home appliance which senses the container using an oscillation signal having at least different oscillation frequencies in a PCB pattern coil structure, thereby increasing a variation ratio of an equivalent resistance based on the material of the container according to the oscillation frequency, and thereby improving the determination performance of the material of the container.

The purposes to be solved according to an embodiment of the present specification are not limited to the above-mentioned purposes, and other purposes not mentioned will be clearly understood by those skilled in the art from the following description.

### Technical Solution

The home appliance according to the present disclosure may include a container sensing sensor that detects at least one of a position, a size, and a material of a container seated on a top plate using an oscillation signal according to change in an equivalent resistance of each of a plurality of sensing coils.

The container sensing sensor of the home appliance according to the present disclosure may include an oscillation circuit which has an adjustable capacitance, and the oscillation circuit may detect at least one of a position, a size, and a material of the container using an oscillation signal resonating at an oscillation frequency determined based on an inductance of the sensing coil and the capacitance.

The container sensing sensor of the home appliance according to the present disclosure detects the container using an oscillation signal resonating with at least different oscillation frequencies, and thus, detect containers having various sizes and materials.

In the home appliance according to the present disclosure, the container sensing sensor may detect a ferromagnetic container using an oscillation signal resonating at a first oscillation frequency, and may detect a paramagnetic container using an oscillation signal resonating at a second oscillation frequency lower than the first oscillation frequency.

A home appliance according to the present disclosure may include: a top plate on which a container may be seated; a plurality of heating coils for heating the container using electromagnetic induction; a plurality of sensing coils electromagnetically coupled to the container to generate equivalent resistance and equivalent inductance when the container may be seated on the top plate; and a plurality of container sensing sensors configured to detect at least one of a position, a size, and a material of the container seated on the top plate, based on an oscillation signal according to change in the equivalent resistance of the plurality of sensing coils.

### Technical Effect

According to the present disclosure, at least one of the position, size, and material of the container seated on the top plate may be accurately sensed using the oscillation signal according to the change in the equivalent resistance of each of the plurality of sensing coils.

Accordingly, the home appliance of the present disclosure may increase the position freedom of the container on the top plate for use convenience in the induction heating cooktop, and may select the driving target heating coil and adjust the intensity of the power to be applied to the selected heating coil, based on the position, size, and material of the container, thereby improving the power control performance/

In addition, the home appliance of the present disclosure may utilize the UI/UX by controlling the UI of the control panel to be turned on, displayed, or alerted based on the position, size, and material of the container, and thereby increase user convenience.

According to the present disclosure, the home appliance of the present disclosure senses the cooking container using the oscillation signal attenuating by the attenuation amount varying due to the equivalent resistance that fluctuates according to the degree of coupling between the cooking container and the sensing coil and the material of the cooking container in the induction heating cooktop, thereby accurately discriminating at least one of the position, size, and material of the container.

The home appliance of the present disclosure may simplify the induction heating cooktop structure and the heating and sensing system by forming the heating coil and the sensing coil into the integrated structure using the PCB pattern coil.

The cooking appliance of the present disclosure may discriminate containers of various sizes and containers of various materials by applying two or more container sensing schemes to an induction heating cooktop having an PCB pattern coil structure in which the heating coil and the sensing coil are integrally formed with each other.

The home appliance of the present disclosure may increase the variation ratio of the equivalent resistance based on the material of the container according to an oscillation frequency by sensing the container using the oscillation signal having at least different oscillation frequencies in the PCB pattern coil structure, thereby improving the discrimination performance of the container material.

### BRIEF DESCRIPTION OF DRAWINGS

FIG. 1 is an exploded perspective view illustrating an exploded state of a cooktop in a home appliance according to an embodiment of the present disclosure.

FIG. 2 is a plan view of the cooktop illustrated in FIG. 1 and a view illustrating a configuration of a PCB pattern coil assembly.

FIG. 3 is a diagram illustrating an arrangement structure of a heating coil and a sensing coil illustrated in FIG. 2.

FIG. 4 is a diagram illustrating a structure of a multi-layered sensing coil PCB in which the sensing coil illustrated in FIG. 2 is disposed.

FIG. 5 is a diagram illustrating a minimum spacing between the sensing coils illustrated in FIG. 2.

FIG. 6 illustrates a circuit of a container sensing sensor provided in a cooktop of a home appliance according to an embodiment of the present disclosure.

FIG. 7 is a diagram illustrating an operation of the container sensing sensor illustrated in FIG. 6.

FIG. 8 is a diagram illustrating an equivalent resistance variation ratio based on a container material according to an oscillation frequency of the container sensing sensor illustrated in FIG. 6.

FIG. 9 is a diagram illustrating a connection relationship of a plurality of container sensing sensors and a controller and an operation thereof.

FIG. 10 is a diagram illustrating an operation of a plurality of container sensing sensors illustrated in FIG. 9.

FIG. 11 is a diagram illustrating an output waveform of each node in a circuit diagram of the container sensing sensor illustrated in FIG. 6.

### DETAILED DESCRIPTIONS

The above-described purposes, features, and advantages will be described in detail with reference to the accompanying drawings, and accordingly, a person having ordinary skill in the art to which the present disclosure pertains will be able to easily implement the technical idea of the present disclosure. In the description of the present disclosure, when it is determined that a detailed description of a known technology related to the present disclosure may unnecessarily obscure the gist of the present disclosure, the detailed description will be omitted. Hereinafter, preferred embodiments according to the present disclosure will be described in detail with reference to the accompanying drawings. In the drawings, the same reference numerals are used to indicate the same or similar components.

Although the first, second, and the like are used to describe various components, it is obvious that these components are not limited by these terms. These terms are used to distinguish only one component from another component. Unless otherwise stated, the first component may be the second component.

The present disclosure is not limited to the embodiments disclosed below, but various changes may be applied thereto and the present disclosure may be implemented in various different forms. However, the present embodiment is provided so that the present disclosure is complete and the scope of the present disclosure is fully informed to those skilled in the art. Therefore, the present disclosure is not limited to the embodiments disclosed below, but it should be understood that a configuration of one embodiment and a configuration of another embodiment are substituted with each other or are added to each other, and all changes, equivalents, and substitutes included in the technical spirit and scope of the present disclosure are included in the present disclosure.

The accompanying drawings are only set forth for easy understanding of the embodiments disclosed in the present disclosure, and the technical spirit disclosed in the present disclosure is not limited by the accompanying drawings, and it should be understood that all changes, equivalents, and substitutes included in the spirit and technical scope of the present disclosure are included in the present disclosure. In the drawings, the components may be expressed to be larger or smaller in size or thickness in consideration of convenience of understanding, etc. However, the scope of the present disclosure should not be limited thereto.

The terms used herein are used only to describe specific embodiments or embodiments, and are not intended to limit the present disclosure. As used herein, the singular constitutes “a” and “an” are intended to include the plural constitutes as well, unless the context clearly indicates otherwise In the present disclosure, terms such as “include” and “comprise” are intended to designate that a feature, a number, a step, an operation, a component, a part, or a combination thereof as described in the present disclosure exist. That is, it should be understood that in the present disclosure, the terms such as “include” and “comprise” do not exclude the presence or addition of one or more other features, numbers, steps, operations, components, parts, or combinations thereof.

Terms including ordinals, such as first, second, etc., may be used to describe various components, but the components are not limited by the terms. The terms are used only for the purpose of distinguishing one component from another component.

When it is mentioned that one component is “connected” or “coupled” to another component, it should be understood that one component may be directly connected or coupled to another component, or still another component may be present therebetween. On the other hand, when it is mentioned that one component is “directly connected” or “directly coupled” to another component, it should be understood that still another component is absent therebetween.

When one component is referred to as “being disposed on top of” or “being disposed under” another component, it should be understood that one component may be directly disposed on top of or under another component or still another component may be present therebetween.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

For example, embodiments in which a heating coil assembly is used in a cooking appliance are described in the present disclosure. However, in some further embodiments, the heating coil assembly may be applied to other home appliances that require induction heating.

For example, the heating coil assembly may be mounted on a washing machine to heat a water tank, a drum, or a washing tub inside the washing machine or to heat washing water.

In another example, the heating coil assembly may be mounted on a water purifier and used to heat a hot water pipe or a water tank.

In still another example, the heating coil assembly may be mounted on a laundry dryer or a laundry care apparatus and used to heat air for drying the laundry.

In still yet another example, the heating coil assembly may be mounted on an electric port or a rice cooker and used to heat a liquid or food therein.

[Overall Structure of Induction Heating Cooktop]

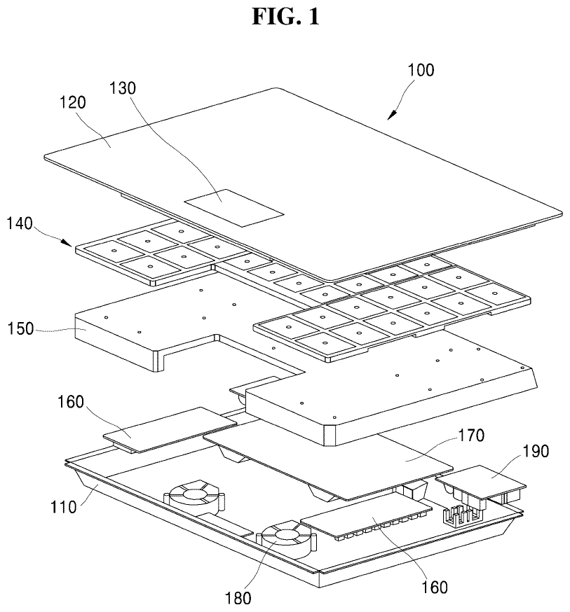

FIG. 1 is an exploded perspective view illustrating an exploded state of an induction heating cooktop 100 in a home appliance according to an embodiment of the present disclosure.

The home appliance according to an embodiment of the present disclosure may be an oven range type home appliance in which the cooktop 100 is disposed in an upper area and an oven is disposed in a lower area. The present disclosure is not limited thereto, and the home appliance according to an embodiment of the present disclosure may be embodied as a home appliance in which the cooktop 100 is provided alone.

Referring to FIG. 1, the home appliance according to an embodiment of the present disclosure includes the induction heating cooktop 100. The induction heating cooktop 100 may include a casing 110 and a top plate 120.

According to the present embodiment, an exterior of the cooktop 100 may be defined by the casing 110 and the top plate 120. The casing 110 may be disposed under the top plate 120, and may constitute a front surface, a rear surface, a side surface, and a bottom surface of the cooktop 100. The top plate 120 may be disposed at a top of the cooktop 100 and may constitute an outer appearance of an upper surface of the cooktop 100. The top plate 120 may be made of ceramic glass for mounting a cooking container thereon.

An accommodation space may be formed inside the casing 110. The accommodation space formed inside the casing 110 may be opened upwardly. In an example, the casing 110 may be formed in a hexahedral shape with an open upper side. In the accommodation space surrounded with the top plate 120 and the casing 110, various internal components constituting the cooktop 100 may be accommodated.

In addition, a PCB pattern coil assembly 140 may be disposed under the top plate 120 in the cooktop 100. In the PCB pattern coil assembly 140, at least one heating coil for heating the cooking container via induction heating and at least one sensing coil for sensing the cooking container may be integrally formed with each other.

For example, the PCB pattern coil assembly 140 may include a plurality of PCB pattern coil assemblies according to a size of the top plate 120 of the cooktop 100. For example, when the top plate 120 is divided into three areas including a left area, a central area, and a right area, three PCB pattern coil assemblies 140 may be respectively disposed under the corresponding areas. The PCB pattern coil assemblies 140 may be formed in different sizes to be suitable for the sizes of the left area, the central area, and the right area, respectively. Each of the PCB pattern coil assemblies 140 corresponding to each area may independently operate.

In the PCB pattern coil assembly 140, the heating coil for induction heating, the sensing coil for sensing the container, a temperature sensor for sensing a temperature, a terminal for connection with other components, etc. may be integrally formed with each other. The PCB pattern coil assembly 140 may be divided into a plurality of unit blocks. In an example, one heating coil may be disposed in one unit block. In an example, at least two sensing coils may be disposed in one unit block. In an example, two sensing coils may be disposed between adjacent unit blocks and across the two adjacent unit blocks.

In addition, in the cooktop 100, a supporter 150 may be disposed under the PCB pattern coil assembly 140. The supporter 150 may constitute a skeleton inside the cooktop 100 so as to support various internal components constituting the cooktop 100. In an example, the supporter 150 may be formed in a hexahedral shape with an open lower side. For example, the supporter 150 may be formed in a shape substantially identical with a shape obtained by turning the casing 110 upside down, and may be formed to have a slightly smaller size than that of the casing 110.

According to the present embodiment, the accommodation space may be formed inside the supporter 150, and may be formed as a space surrounded by the bottom portion of the casing 110 and the supporter 150. Various internal components constituting the cooktop 100 may be accommodated in the supporter 150.

For example, a resonant PCB assembly 160 in which capacitors used for resonance or oscillation are mounted, an inverter PCB assembly 170 in which a switching element for applying a current to the heating coil for induction heating, etc. are mounted, a fan 180 for cooling down the internal components, an EMI filter 190 for filtering and blocking various noises mixed with each other on electrical power, and a control PCB assembly in which a controller for controlling the overall operation of the cooktop 100 and circuits for sensing the cooking container are mounted may be accommodated in the supporter 190.

According to the present embodiment, the supporter 150 may also provide a base function for the PCB pattern coil assembly 140. More specifically, a ferrite core may be installed on an upper surface of the supporter 150, the PCB pattern coil assembly 140 may be installed on top of the ferrite core, and the top plate 120 may be installed on top of the PCB pattern coil assembly 140.

In addition, the cooktop 100 may include a control panel 130. The control panel 130 may be disposed on one area of an upper surface of the top plate 120. The control panel 130 may include a UI (user interface) including an adjustment icon for adjusting an operation of the cooktop 100 in a touch manner and a display for displaying an operation state of the cooktop 100.

### [PCB Pattern Coil Assembly]

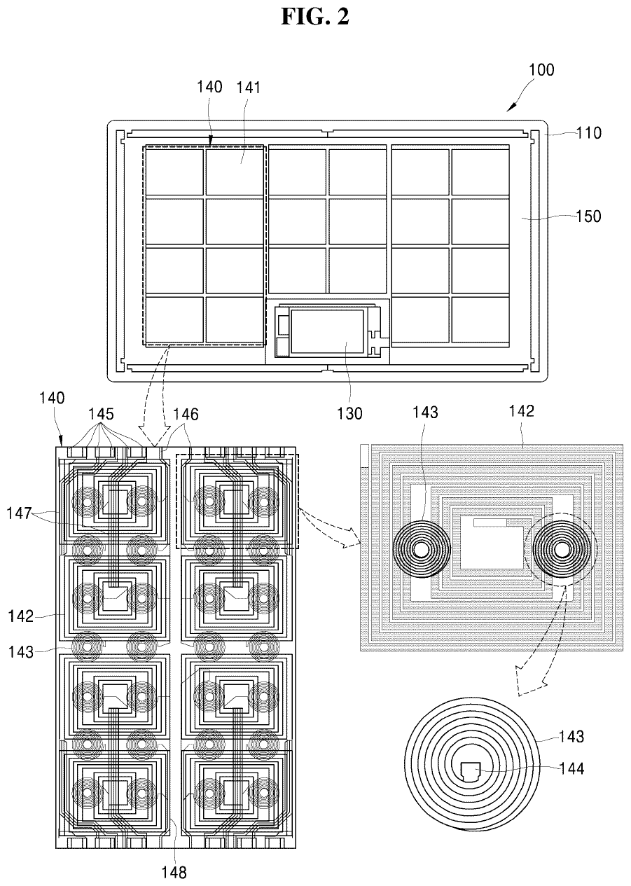

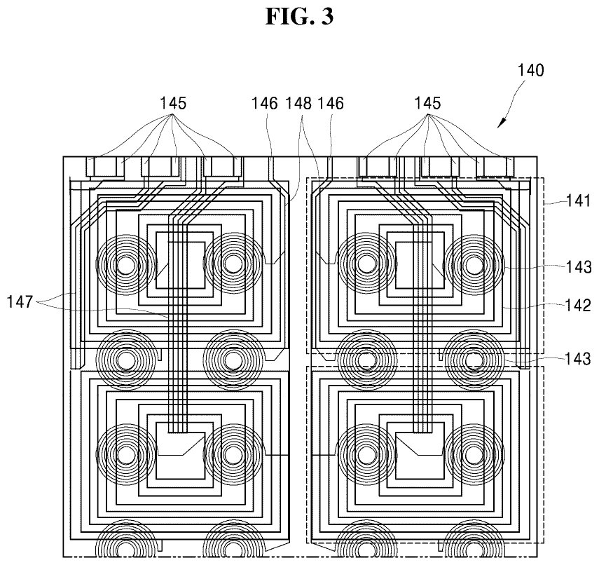

FIG. 2 is a plan view illustrating the cooktop 100 illustrated in FIG. 1 and a configuration of the PCB pattern coil assembly 140. FIG. 3 is a diagram illustrating an arrangement structure of a heating coil 142 and a sensing coil 143 illustrated in FIG. 2.

Referring to FIGS. 2 and 3, the cooktop 100 may include the casing 110, the supporter 150, and the PCB pattern coil assembly 140. The PCB pattern coil assembly 140 includes the heating coil 142 for induction heating of the cooktop 100 and the sensing coil 143 for sensing the cooking container, and may be disposed in the accommodation space inside the cooktop 100.

The supporter 150 may be disposed on top of the casing 110, the PCB pattern coil assembly 140 may be disposed on top of the supporter 150, and the top plate 120 may be disposed on top of the PCB pattern coil assembly 140.

The PCB pattern coil assembly 140 may include a plurality of PCB pattern coil assemblies according to the size and shape of the cooktop 100. In the present embodiment, it is illustrated that the cooktop 100 is divided into the left area, the central area, and the right area, and includes three PCB pattern coil assemblies 140 corresponding thereto. Each of the PCB pattern coil assemblies 140 may include a plurality of heating coils 142 and a plurality of sensing coils 143.

Each of the PCB pattern coil assemblies 140 may be divided into a plurality of unit blocks 141. The plurality of unit blocks 141 may be arranged in a matrix form. For example, at least one heating coil 142 may be disposed in one unit block 141. For example, at least two sensing coils 143 may be disposed in one unit block 141. In addition, at least two sensing coils 143 may be disposed between adjacent two unit blocks 141 and across the adjacent two unit blocks 141.

Each of the heating coil 142 and the sensing coil 143 formed in the PCB pattern coil assembly 140 may be disposed in a pattern form on a board. In an example, the heating coil 142 may be formed in a polygonal, for example, a square, a rectangular, or a hexagonal pattern. Alternatively, the heating coil 142 may be formed in an annular pattern. For example, the sensing coil 143 may be formed in a circular pattern. Alternatively, the sensing coil 143 may be formed in a circular, square, rectangular, or hexagonal pattern.

In addition, at least one heating coil terminal 145, at least one sensing coil terminal 146, at least one heating coil wiring 147, at least one sensing coil wiring 148, and at least one via may be formed in the PCB pattern coil assembly 140. The heating coil terminal 145 is electrically connected to the heating coil 142 via the heating coil wiring 147, and is electrically connected to the resonant PCB assembly 160 and the inverter PCB assembly 170. The sensing coil terminal 146 is electrically connected to the sensing coil 143 via the sensing coil wiring 148, and is electrically connected to the resonant PCB assembly 160 and the control PCB assembly.

As described above, not only the heating coil 142 but also the sensing coil 143 may be formed in the unit block 141 of the PCB pattern coil assembly 140. In the unit block 141, a plurality of sensing coils 143 are arranged along a front-rear direction, and a plurality of sensing coils 143 are also arranged in a lateral direction.

The PCB pattern coil assembly 140 may include a PCB (hereinafter, referred to as a “heating coil PCB”) on which the heating coil 142 is patterned and a PCB (hereinafter, referred to as a “sensing coil PCB”) on which the sensing coil 143 is patterned. The PCB pattern coil assembly 140 may be formed in a form in which the heating coil PCB and the sensing coil PCB are stacked in an up-down direction. In one example, the heating coil PCB may be formed in a form in which 10 to 12 layers are stacked, and the heating coils 142 of the layers may be electrically connected to each other via the via. In one example, the sensing coil PCB may be formed in a form in which two layers are stacked, and the sensing coils 143 of the layers may be electrically connected to each other via the via.

In addition, at least one of the heating coil PCB and the sensing coil PCB may be provided in a form in which the coil is patterned on each of both opposite surfaces of the board. In the present embodiment, it is illustrated that the heating coil 142 is patterned on each of both opposing surfaces of the heating coil PCB, and the sensing coil 143 is patterned on each of both opposing surfaces of the sensing coil PCB.

Each of the sensing coils 143 may be disposed to overlap an area where each of the heating coils 142 is formed, as shown in FIGS. 2 and 3. In addition, each of the sensing coils 143 may be disposed to overlap an area between two adjacent areas where the two heating coils 142 are formed, respectively.

In the present embodiment, it is illustrated that two sensing coils 143 are disposed in the area where each heating coil 142 is formed, and two sensing coils 143 are disposed between the two heating coils 142 adjacent to each other in the front-rear direction. In addition, a temperature sensor 144 may be provided in the PCB pattern coil assembly 140. In one example, the temperature sensor 144 may be disposed in a center portion of an area of each sensing coil 143.

In an example, the PCB pattern coil assembly 140 may be provided in a form in which the heating coil 142, the sensing coil 143, and the temperature sensor 144 are integrally formed with each other. For example, the PCB pattern coil assembly 140 may be formed in a form in which the heating coil PCB having the heating coil 142 and the sensing coil PCB having the sensing coil 143 and the temperature sensor 144 are stacked. The PCB pattern coil assembly 140 may be provided in a form including one or more pattern coil PCBs.

As described above, the PCB pattern coil assembly 140 has a structure in which a plurality of heating coils 142 for induction heating and a plurality of sensing coils 143 for sensing the cooking container mounted on the ceramic glass are integrally formed with each other using the patterns printed on the PCB. The number of heating coils 142 and sensing coils 143 may be determined based on the size of the cooktop 100.

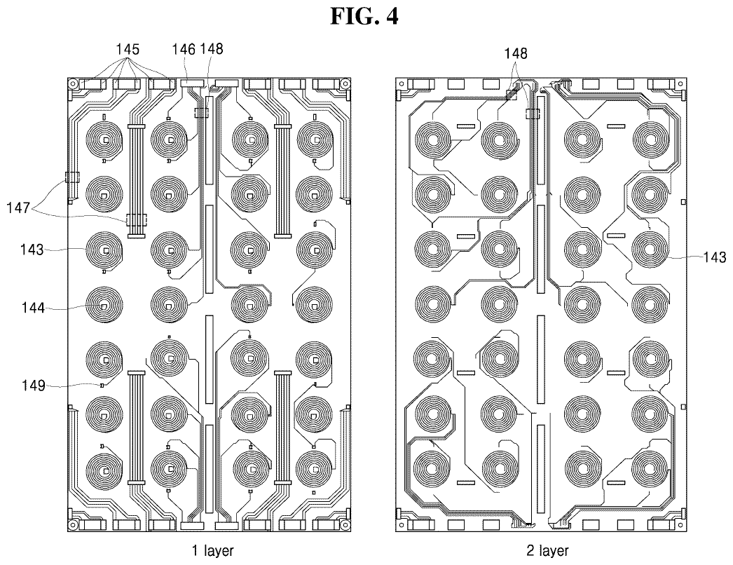

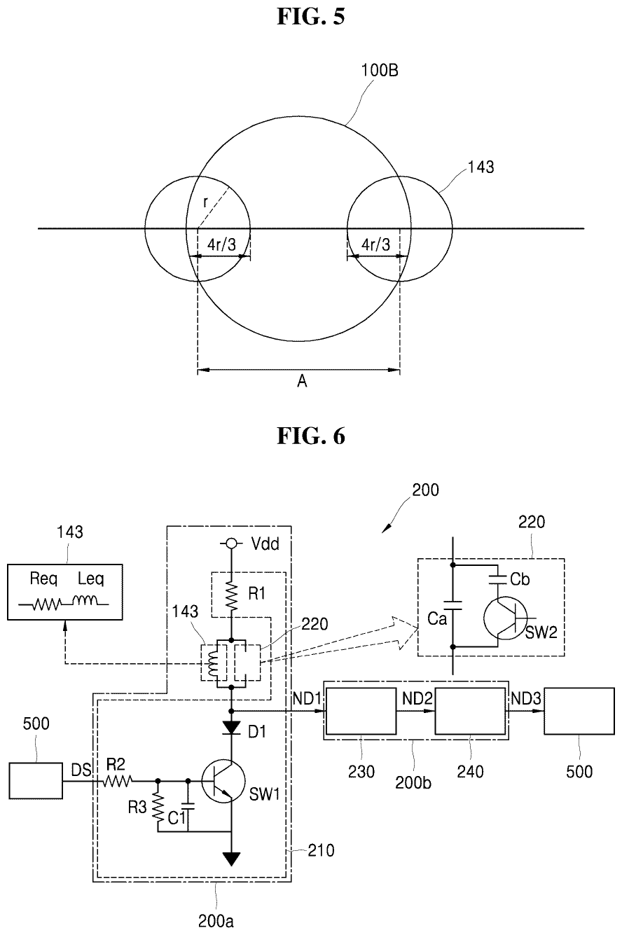

FIG. 4 is a diagram illustrating a multi-layered structure of sensing coil PCBs in which the sensing coil illustrated in FIG. 2 is disposed. FIG. 5 is a diagram illustrating a minimum spacing between the sensing coils illustrated in FIG. 2.

As shown in FIG. 4, the sensing coil PCBs may be stacked in a plurality of layers. In the present embodiment, a structure in which the sensing coil PCBs are stacked in two layers is illustrated.

A plurality of sensing coils 143 may be disposed in each layer of the sensing coil PCB. In an example, at least one heating coil terminal 145, at least one heating coil wiring 147, at least one sensing coil terminal 146, at least one sensing coil wiring 148, at least one via 149, and at least one temperature sensor 144 may be disposed in the sensing coil PCB of each layer.

The heating coil terminal 145 may be electrically connected to the heating coil wiring 147, and the heating coil wiring 147 may be electrically connected to the heating coil 142 of the heating coil PCB via the via. In addition, the sensing coil terminal 146 may be electrically connected to the sensing coil 143 via the sensing coil wiring 148, and the sensing coil 143 may be electrically connected to the sensing coil 143 of another layer via the via 149.

In this embodiment, the sensing coil 143 pattern may be printed on the PCB in a circular shape. Alternatively, the sensing coil 143 pattern may be printed on the PCB in a polygonal shape including a circular shape. The pattern of the sensing coil 143 may be composed of one layer or a plurality of layers of the entire PCB coil. When the pattern of the sensing coil 143 is composed of the plurality of layers, the sensing coils 143 of the layers may be electrically connected to each other via the via 149 of the PCB. In addition, the heating coil wiring 147 connected to the heating coil terminal 145 may be positioned in the layer of the sensing coil 143, and may be disposed separately from the heating coil 143.

As described above, in the PCB pattern coil assembly 140 in the present embodiment, when the heating coil 142 and the sensing coil 143 are constructed into an integrated structure composed of one component using a multilayer PCB board, the sensing coil 143 may be formed in a circular or polygonal shape using one or more layers.

The sensing coil 143 may be disposed between ones of the plurality of heating coils 142 adjacent to each other, or may be disposed on top of the heating coil 142. In addition, the sensing coils 143 may be arranged so as to be spaced from each other by an equal spacing in an upper-down direction and a left-right direction. In addition, as shown in FIG. 5, the spacing between the sensing coils 143 may be smaller than a distance A based on a size of a minimum cooking container 100B that can be heated in the cooktop 100. In this regard, the distance A is a distance between center points of the two sensing coils 143. The distance A may be set to a distance smaller than a diameter of a bottom surface of the minimum cooking container 100B.

### [Container Sensing Sensor]

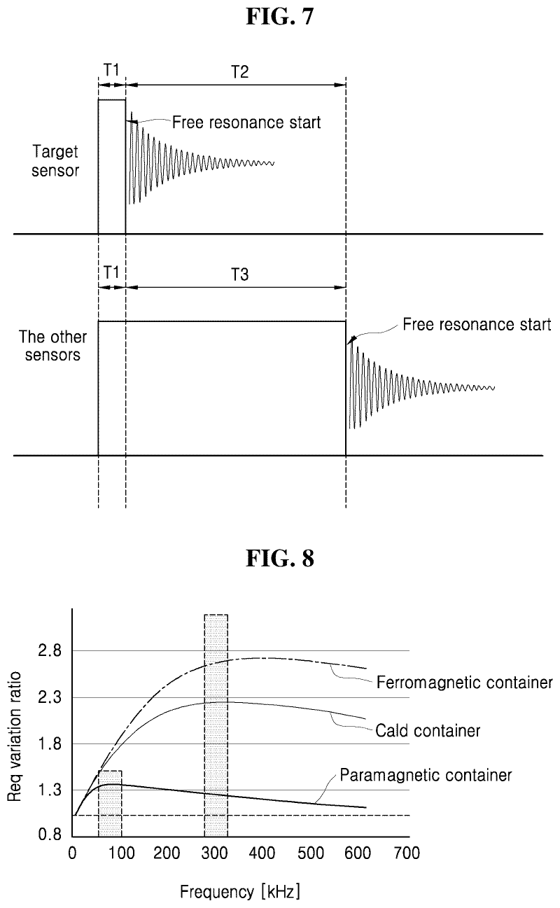

FIG. 6 illustrates a circuit of a container sensing sensor 200 provided in a cooktop of a home appliance according to an embodiment of the present disclosure. FIG. 7 is a diagram illustrating an operation of the container sensing sensor 200 illustrated in FIG. 6. FIG. 8 is a diagram illustrating an equivalent resistance variation ratio based on a container material according to an oscillation frequency of the container sensing sensor 200 illustrated in FIG. 6.

Referring to FIGS. 6 to 8, the home appliance according to an embodiment of the present disclosure includes the container sensing sensor 200 and a controller 500. The container sensing sensor 200 detects the cooking container mounted on the top plate 120 of the cooktop 100 and provides a container sensing signal according to the sensing to the controller 500. The controller 500 controls the operation of the container sensing sensor 200, and determines container information including at least one of a position, a material, a shape, and a size of the container based on the container sensing signal received from the container sensing sensor 200.

The container sensing sensor 200 includes a container sensing circuit 200a and a sensing output circuit 200b. The container sensing circuit 200a stores oscillation energy in a sensing coil 143 according to a driving signal DS of the controller 500 or outputs an oscillation signal that freely resonates. The sensing output circuit 200b filters the DC component from the oscillation signal received from the container sensing circuit 200a, compares the filtered oscillation signal with a reference signal, and outputs a container sensing signal based on the comparison result to the controller 500.

In the present embodiment, the container sensing circuit 200a includes a sensing coil 143, an oscillation circuit 220, and an oscillation driving circuit 210.

When the container is mounted on the top plate 120 of the cooktop 100, the sensing coil 143 is electromagnetically coupled to the container, and thus has an equivalent resistance Req and an equivalent inductance Leq. As described above, a plurality of sensing coils 143 together with the heating coil 142 are formed in the PCB pattern coil assembly 140 using the pattern printed on the PCB.

The oscillation circuit 220 is electrically connected to the sensing coil 143 to generate an oscillation signal that resonates with an oscillation frequency determined based on an inductance of the sensing coil 143 and a capacitance of an oscillation capacitor. The oscillation circuit 220 may be connected in parallel with the sensing coil 143. The oscillation circuit 220 may include at least one oscillation capacitor. In the present embodiment, the oscillation circuit 220 is illustrated as including two oscillation capacitors Ca and Cb.

The oscillation circuit 220 may include a first oscillation capacitor Ca, a second oscillation capacitor Cb, and an adjustment switch SW2. The first oscillation capacitor Ca is connected in parallel with the sensing coil 143, the second oscillation capacitor Cb is connected in parallel with the first oscillation capacitor Ca, and the adjustment switch SW2 is connected in parallel with the first oscillation capacitor Ca and is connected in series with the second oscillation capacitor Cb. The adjustment switch SW2 is used to adjust the oscillation frequency.

The adjustment switch SW2 may be turned on or off under the control of the controller 500. When the adjustment switch SW2 is turned off, the oscillation frequency is determined based on the inductance of the sensing coil 143 and the capacitance of the first oscillation capacitor Ca. The oscillation frequency at which the adjustment switch SW2 is turned on is determined based on the inductance of the sensing coil 143 and the capacitance of each of the first oscillation capacitor Ca and the second oscillation capacitor Cb.

The oscillation circuit 220 adjusts the oscillation frequency of the oscillation signal by adjusting the capacitance value according to the switching of the adjustment switch SW2. The adjustment of the oscillation frequency may improve the determination performance of the container material by increasing a variation ratio of the equivalent resistance Req based on the container material when the container sensing sensor 200 determines the container material, for example, the magnetic container and the non-magnetic container, or the ferromagnetic container and the paramagnetic container.

The oscillation driving circuit 210 includes a driving switch SW1. The oscillation driving circuit 210 drives the sensing coil 143 and the oscillation circuit 220 such that the sensing coil 143 stores oscillation energy therein or the oscillation circuit 220 outputs the oscillation signal to the sensing output circuit 200b according to the operation of the driving switch SW1. When the driving switch SW1 is turned on, the oscillation energy by a power voltage Vdd is stored in the sensing coil 143. When the driving switch SW1 is turned off, the oscillation energy stored in the sensing coil 143 may freely resonate through the oscillation circuit 220, and may be output as the oscillation signal freely resonating at the oscillation frequency.

In the present embodiment, the oscillation driving circuit 210 includes a first resistor R1, a first diode D1, the driving switch SW1, a second resistor R2, a third resistor R3, and a first capacitor C1.

One end of the first resistor R1 is connected to a power voltage Vdd terminal and the other end thereof is connected to the sensing coil 143 and the oscillation circuit 220. The first resistor R1 is a current limiting resistor and drops the power voltage Vdd. The first diode D1 has an anode electrode connected to the sensing coil 143 and the oscillation circuit 220, and a cathode electrode connected to the driving switch SW1. The first diode D1 transmits the power resulting from the sensing coil 143 and the oscillation circuit 220 to the driving switch SW1 and blocks noise, for example, surge power, which may be introduced from the driving switch SW1.

The driving switch SW1 has a first electrode connected to the cathode electrode of the first diode D1, a second electrode connected to ta ground voltage, and a gate electrode connected to a terminal receiving the driving signal DS. The driving switch SW1 is turned on or off according to the driving signal DS received from the controller 500.

The second resistor R2 is disposed between and connected to the terminal receiving the driving signal DS and the gate electrode of the driving switch SW1. The third resistor R3 and the first capacitor C1 are connected in parallel with each other and are disposed between and connected to the gate electrode of the driving switch SW1 and the ground voltage terminal. When the driving signal DS is received from the controller 500, the second resistor R2, the third resistor R3, and the first capacitor C1 maintain a potential level of the driving signal DS at a turn-on level of the driving switch SW1.

The oscillation driving circuit 210 may include an output node ND1 that outputs the oscillation signal that freely resonates when the driving switch SW1 is turned off. The output node ND1 may be formed between one end of the sensing coil 143 and the oscillation circuit 220 and the anode electrode of the first diode D1.

In the present embodiment, the sensing output circuit 200b includes an DC blocking circuit 230 and a comparison circuit 240. The DC blocking circuit 230 blocks the DC signal included in the oscillation signal OSC and outputs only the oscillation signal OSC that resonates. The comparison circuit 240 compares the oscillation signal OSC with a reference signal, and outputs the container sensing signal according to the comparison result to the controller 500. In FIG. 6, a node ND2 represents an output node of the DC blocking circuit 230, and a node ND3 represents an output node of the comparison circuit 240.

The controller 500 determines at least one of the container position and the container material based on the number of pulses of the container sensing signal output from the sensing output circuit 200b. For example, an attenuation amount by which the oscillation signal is attenuated varies due to the equivalent resistance Req varying based on the degree of electromagnetic coupling between the container and the sensing coil 143 and based on the material of the container. The controller 500 determines the container position and the container material based on a change in the container sensing signal according to the oscillating signal varying in this way.

In the present embodiment, the controller 500 turns off the adjustment switch SW2 of the oscillation circuit 220 of the container sensing sensor 200, and determines a container of a first material based on the number of pulses of the container sensing signal according to the variation of the oscillation signal resonating at a first oscillation frequency determined based on the inductance of the sensing coil 143 and the capacitance of the first oscillation capacitor Ca via the turn-off of the adjustment switch SW2. In an example, an example of the container of the first material may include a ferromagnetic material cooking container or a magnetic cooking container.

In addition, in the present embodiment, the controller 500 turns on the adjustment switch SW2 of the oscillation circuit 220 of the container sensing sensor 200, and determines a container of a second material based on the number of pulses of the container sensing signal according to the variation of the oscillation signal resonating at a second oscillation frequency determined based on the inductance of the sensing coil 143 and the capacitance of a combination of the first oscillation capacitor Ca and the second oscillation capacitor Cb connected in parallel to each other via the turn-on of the adjustment switch SW2. In an example, the second oscillation frequency has a lower frequency value than the first oscillation frequency. An example of the container of the second material may include a paramagnetic material cooking container or a non-magnetic cooking container.

In the present embodiment, the container sensing sensor 200 may use the oscillation signal resonating at the first oscillation frequency to detect the ferromagnetic container, and may use the oscillation signal resonating at the second oscillation frequency lower than the first oscillation frequency to detect the paramagnetic container. The container sensing sensor 200 may periodically perform a process of detecting the container position and the container material using the oscillation signal resonating at the first oscillation frequency or the second oscillation frequency.

[Overall Operation of Container Sensing Sensor]

The operation over time of the container sensing sensor 200 of the present disclosure will be described as follows. First, the container sensing sensor 200 turns on the driving switch SW1 connected to the sensing coil 143. Then, a predetermined amount of energy from the power voltage Vdd is stored in the sensing coil 143.

After a predetermined time duration has elapsed, the container sensing sensor 200 turns off the driving switch SW1. Then, the oscillation signal that resonates at the first oscillation frequency determined based on the first oscillation capacitor Ca of the oscillation circuit 220 connected in parallel to the sensing coil 143 is output. In this regard, the attenuation amount by which the oscillation signal is attenuated varies due to the equivalent resistance Req that fluctuates based on the degree of electromagnetic coupling between the container and the sensing coil 143 and based on the container material.

In this regard, the first oscillation frequency is calculated as ½π\sqrt{L_{aq}C}. In this regard, C denotes a capacitance value of the first oscillation capacitor Ca, and Leq denotes an equivalent inductance of the sensing coil 143. The attenuation amount by which the oscillation signal is attenuated due to the equivalent resistance Req of the sensing coil 143 is calculated as

$$\frac{{R}_{eq}}{2} \sqrt{\frac{C}{{L}_{eq}}} .$$

In one example, the oscillation signal resonating at the first oscillation frequency is used to sense the ferromagnetic container.

Next, the container sensing sensor 200 filters the DC signal from the oscillation signal resonating at the first oscillation frequency, compares the filtered oscillation signal with the reference signal, and outputs the container sensing signal according to the comparison result to the controller 500.

In the present embodiment, the controller 500 determines the container position and the ferromagnetic strength of the ferromagnetic material based on the container sensing signal according to the variation of the oscillation signal that resonates at the first oscillation frequency. Thereafter, the controller 500 may drive the heating coil at the determined position with appropriate power based on the ferromagnetic strength of the ferromagnetic container.

Next, the container sensing sensor 200 turns on the adjustment switch SW2 of the oscillation circuit 220 to connect the first oscillation capacitor Ca and the second oscillation capacitor Cb in parallel with each other, thereby forming an equivalent capacitance.

Next, the container sensing sensor 200 turns on the driving switch SW1 connected to the sensing coil 143. Then, a predetermined amount of energy from the power voltage Vdd is stored in the sensing coil 143.

After the predetermined time duration has elapsed, the container sensing sensor 200 turns off the driving switch SW1. Then, the oscillation signal that resonates at the second oscillation frequency determined based on the inductance of the sensing coil 143 and a capacitance of a combination of the first oscillation capacitor Ca and the second oscillation capacitor Cb connected in parallel with each other is output. In this regard, the attenuation amount by which the oscillation signal is attenuated varies due to the equivalent resistance Req fluctuating based on the degree of electromagnetic coupling between the container and the sensing coil 143 and based on the container material.

In this regard, the second oscillation frequency is calculated as ½π\sqrt{L_{aq}C}. In this regard, C denotes a capacitance value of a combination of the first oscillation capacitor Ca and the second oscillation capacitor Cb connected in parallel to each other, and Leq denotes an equivalent inductance of the sensing coil 143. The attenuation amount by which the oscillation signal is attenuated due to the equivalent resistance Req of the sensing coil 143 is calculated as

$$\frac{{R}_{eq}}{2} \sqrt{\frac{C}{{L}_{eq}}} .$$

In one example, the oscillation signal resonating at the second oscillation frequency is used to sense the paramagnetic container.

The container sensing sensor 200 filters the DC signal from the oscillation signal resonating at the second oscillation frequency, compares the filtered oscillation signal with the reference signal, and outputs the container sensing signal according to the comparison result to the controller 500.

The controller 500 determines the container position and the paramagnetic strength of the paramagnetic material based on the container sensing signal according to the variation of the oscillation signal resonating at the second oscillation frequency. Thereafter, the controller 500 may drive the heating coil at the determined position with appropriate power based on the paramagnetic strength of the paramagnetic container.

The above container sensing operation may be periodically performed before induction heating and during induction heating when the cooktop is powered on.

In the present embodiment, referring to FIG. 7, while at least one container sensing sensor among the plurality of container sensing sensors 200 detects the container using the oscillation signal that freely resonates, each of the remaining container sensing sensors discharges the energy charged in the sensing coil 143. In FIG. 7, a first period T1 represents a period for which the sensing coil is charged with the oscillation energy. A second period T2 represents a period for which at least one of the position, size, and material of the container is sensed and determined using the oscillation signal that resonates freely. A third period T3 represents a discharge period for which the energy stored in the sensing coil is discharged.

Referring to FIG. 7, first, all each of the plurality of container sensing sensors 200 stores the oscillation energy in the sensing coil 143 by turning on the driving switch SW1 during the first period T1.

After a predetermined time duration has elapsed, a target sensor of the plurality of container sensing sensors 200 generates the oscillation signal that freely resonates by turning off the driving switch SW1 during the second period T2. In this case, the attenuation amount by which the oscillation signal is attenuated varies due to the equivalent resistance varying based on the degree of electromagnetic coupling between the container and the sensing coil and the material of the container. Then, the controller 500 determines at least one of the position, size, and material of the container based on the container sensing signal according to the oscillation signal fluctuating according to the presence or absence of the container and the material of the container.

After a predetermined time duration has elapsed, each of the remaining sensors maintains the driving switch SW1 at the turned-on state during the third period T3, such that the energy stored in the sensing coil 143 according to the voltage induction is discharged to the ground through the driving switch SW1.

As described above, the container sensing sensor 200 detects the container based on the different oscillation frequencies of the oscillation signal, and the controller 500 determines the container information including at least one of the position, material, shape, and size of the container using the container sensing signal according to the variation of the equivalent resistance Req based on the container material according to the oscillation frequency.

Referring to FIG. 8, the magnitude of the variation ratio of the equivalent resistance (Req) based on the oscillation frequency varies based on the container material. As the value of the variation ratio of the equivalent resistance Req increases, the performance of determining the container may be increased. Thus, the container sensing sensor 200 adjusts the oscillation frequency to detect the container during the container sensing period.

The container sensing sensor 200 may detect the ferromagnetic container using the oscillation signal resonating at the first oscillation frequency, and may detect the paramagnetic container using the oscillation signal resonating at the second oscillation frequency lower than the first oscillation frequency. For example, the container sensing sensor 200 may detect the ferromagnetic container made of, for example, iron, cobalt, nickel, silicon steel, cast iron or clad, etc. using a frequency of 300 KHz, and may detect the paramagnetic container made of, for example, aluminum, platinum, silver, or copper, etc. using a frequency smaller than 100 KHz.

The type of the magnetic material is identified based on whether specific permeability is generated. The specific permeability of the material is calculated as the permeability of the material/the permeability of the vacuum, and indicates how many times the permeability of the material is compared to the vacuum permeability. In the present disclosure, the ferromagnetic material may be defined as a material having the specific permeability much larger than 1. The ferromagnetic material has strong magnetic properties, and the magnetic properties of the ferromagnetic material may change according to the temperature and the external magnetic field. The ferromagnetic material may maintain the magnetic properties even when the external magnetic field is removed. Iron, cobalt, nickel, etc. are typical ferromagnetic materials. The paramagnetic material may be defined as a material having the specific permeability equal to or slightly larger than 1. The paramagnetic material has paramagnetic properties and has magnetic properties easily changing depending on the external magnetic field or temperature. Aluminum, platinum, platinum, etc. are representative paramagnetic materials. The non-magnetic material may be defined as a material having the specific permeability equal to or smaller than 1. The non-magnetic material weakly reacts with the magnetic field and has very weak magnetism. Copper, silver, gold, and quartz are representative non-magnetic materials.

The controller 500 determines at least one of the container position and the container material based on the number of pulses of the container sensing signal output from the sensing output circuit 200b. For example, the attenuation amount by which the oscillation signal is attenuated varies due to the equivalent resistance Req varying based on the degree of electromagnetic coupling between the container and the sensing coil 143 and the material of the container. The controller 500 determines the container position and the container material based on the change in the container sensing signal according to the oscillating signal varying in this way.

Data on the variation ratio of the equivalent resistance (Req) based on the container material according to the oscillation frequency may be stored in the memory. The controller 500 may determine the container material based on a comparing result of the data determined based on the container sensing signal with the data on the equivalent resistance variation ratio based on the container material stored in the memory.

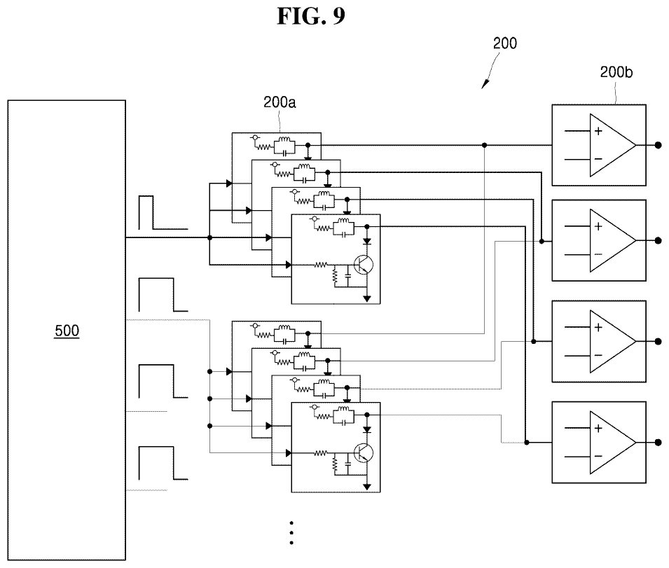

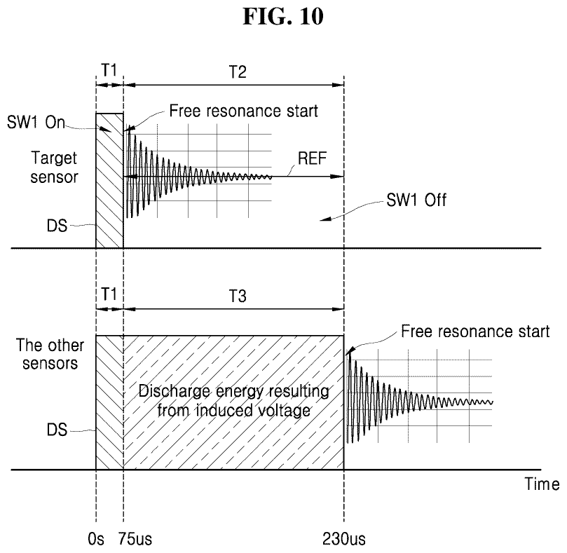

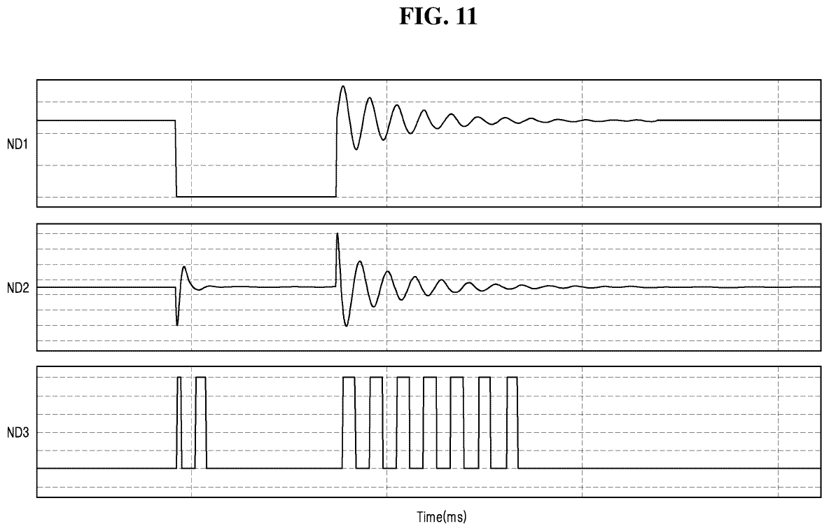

FIG. 9 is a diagram illustrating a connection relationship of a plurality of container sensing sensors and a controller and an operation thereof. FIG. 10 is a diagram illustrating an operation of a plurality of container sensing sensors illustrated in FIG. 9. FIG. 11 is a diagram illustrating an output waveform of each node in the circuit diagram of the paper sensing sensor illustrated in FIG. 6.

Referring to FIGS. 9 to 11, in the present embodiment, the controller 500 may simultaneously drive at least a few container sensing sensors among the plurality of container sensing sensors in one grouped manner.

In the present embodiment, the controller 500 is illustrated as simultaneously driving four container sensing sensors. However, the present disclosure is not limited thereto. The number of container sensing sensors 200 that are simultaneously driven may be changed according to the size of the top plate 120 of the cooktop 100 or the number of sensing coils 143.

Each of the container sensing sensors 200 includes the container sensing circuit 200a and the sensing output circuit 200b. In the present embodiment, the number of container sensing circuits 200a may be equal to the number of the sensing coils 143. The container sensing circuits 200a of the container sensing sensors 200 may be grouped into a plurality of groups, each group including four container sensing circuits 200a. The container sensing circuits 200a in one group may simultaneously operate to detect the container.

In addition, in the present embodiment, each group of the container sensing circuits 200a may share the four sensing output circuits 200b. The four sensing output circuits 200b may be sequentially connected to the container sensing circuits 200a of each group, respectively. In an example, when a first group of container sensing circuits 200a operates, the four sensing output circuits 200b may be connected to the first group of container sensing circuits 200a, and may be disconnected from the remaining groups of sensing output circuits 200b.

Thereafter, when a second group of the container sensing circuits 200a operates, the four sensing output circuits 200b may be connected to the container sensing circuits 200a of the second group, and may be disconnected from the remaining groups of sensing output circuits 200b. In this manner, the four sensing output circuits 200b may be sequentially connected to each of the groups and output the oscillation signal of each group as the container sensing signal.

In the present embodiment, the controller 500 controls the container sensing circuits 200a of the four target container sensing sensors such that the oscillation energy charged in the four sensing coils 143 of one group freely resonates. In addition, the controller 500 controls the container sensing circuits 200a of the remaining container sensing sensors so that the oscillation energy stored in the remaining groups of the sensing coils 143 is discharged.

In addition, in the present embodiment, the controller 500 sequentially receives the container sensing signal of each group from the four sensing output circuits 200b, and determines the container information including at least one of the position, material, shape, and size of the container based on the container sensing signal.

In the present embodiment, when the cooktop 100 includes 16 container sensing sensors 200, the controller 500 may drive 16 container sensing sensors 200 using four input pins and may receive the container sensing signals from the 16 container sensing sensors 200 using four output pins.

As described above, in the present embodiment, the number of input pins and output pins of the controller 500 may be reduced, and thus, the number of wiring disposed between and connected to the elements may be reduced. Accordingly, a space inside the cooktop 100 may be secured.

Referring to FIGS. 6 and 10, the controller 500 provides the driving signal DS for turning on the driving switch SW1 of the oscillation driving circuit 210 to all the container sensing sensors 200 during the first period T1. The oscillation driving circuits 210 of all the container sensing sensors 200 operate such that the oscillation energy is stored in each of the sensing coils 143 via turning-on of the driving switch SW1.

After a first time duration has elapsed, the controller 500 provides the driving signal DS for turning off the driving switch SW1 to the oscillation driving circuit 210 of a target container sensing sensor during the second period T2. In addition, the controller 500 provides the driving signal DS for maintaining the turned-on state of the driving switch SW1 to the oscillation driving circuits 210 of the remaining container sensing sensors during the third period T3.

The target container sensing sensor may be defined as a sensor driven to detect the container. The remaining container sensing sensors may be defined as sensors waiting while the target container sensing sensor detects the container. In FIG. 10, the first time duration is 75 μs. However, the present disclosure is not limited thereto. The first time duration may be set as a time duration from a time point at which the oscillation energy is stored in the sensing coil 143 to a time point at which the energy is discharged therefrom.

The oscillation circuit 220 of the target container sensing sensor generates the oscillation signal that freely resonates via turning-off of the driving switch SW1 during the second period T2 under the control of the controller 500. In this regard, the controller 500 may determine the container information including at least one of the position, material, shape, and size of the container based on the container sensing signal according to the oscillation signal varying according to the presence or absence of the container and the container material.

In addition, according to the control of the controller 500, the oscillation circuits 220 of the remaining container sensing sensors discharge the oscillation energy stored in the remaining sensing coils 143 to the ground through the driving switch SW1 via turning-on of the driving switch SW1 during the third period T3. The driving switches SW1 of the oscillation driving circuits 210 of the remaining container sensing sensors may be maintained at the turned on state for a second time duration. In FIG. 10, the second time duration is 230 μs. However, the present disclosure is not limited thereto. The second time duration may be set to a time duration required for the target container sensing sensor to detect the container and for the controller 500 to determine the container.

In FIGS. 6 and 11, the first node ND1 may be defined as a node of the oscillation circuit 220 that outputs the oscillation signal. The second node ND2 may be defined as a node of the DC blocking circuit 230 that outputs a filtered oscillation signal obtained by filtering DC included in the oscillation signal. The third node ND3 may be defined as a node of the comparison circuit 240 comparing the filtered oscillation signal with the reference signal, the node outputting the container sensing signal according to the comparison result.

As shown in FIG. 11, during the turn-off of the driving switch SW1, the oscillation signal freely resonates, and the container sensing signal is output in the form of a pulse. In this case, the container sensing signal may be output so as to vary based on the number of pulses according to the oscillation signal attenuating by the attenuation amount varying due to the equivalent resistance that varies based on the degree of electromagnetic coupling between the container and the sensing coil and the material of the container. In the present embodiment, the controller 500 may determine the position on the top plate at which the container is seated, the size of the container, and the material of the container based on the container sensing signal output in the form of the pulse.

In the present embodiment, the controller 500 may control the adjustment switch SW2 of the oscillation circuit 220 to detect the container using the oscillation signal resonating at the at least two oscillation frequencies to adjust the oscillation frequency.

The controller 500 may turn off the adjustment switch SW2 of the oscillation circuit 220 such that the oscillation signal resonating at the first oscillation frequency determined based on the inductance of the sensing coil 143 and the capacitance of the first oscillation capacitor Ca is output.

In addition, the controller 500 may turn on the adjustment switch SW2 of the oscillation circuit 220 such that the oscillation signal resonating at the second oscillation frequency determined based on the inductance of the sensing coil 143 and the capacitance of the combination of the first oscillation capacitor Ca and the second oscillation capacitor Ca connected in parallel to each other is output. In this regard, the first oscillation frequency may be set to have a value greater than the second oscillation frequency. The oscillation signal resonating at the first oscillation frequency may be used to sense the ferromagnetic container, while the oscillation signal resonating at the second oscillation frequency may be used to sense the paramagnetic container.

The controller 500 may turn on or display a UI for driving at least one corresponding heating coil among the plurality of heating coils 142, based on the determined position or size of the container, on the control panel 130 such that the user recognizes the UI. In addition, the controller 500 may adjust the intensity of power to be applied to the heating coil 142 so as to vary based on the material of the container. For example, the controller 500 may drive the heating coil 142 with the power controlled such that the power for the ferromagnetic container having strong magnetism has a lower strength than that of the power for the paramagnetic container having weak magnetism. The strength of the power based on the container material or the strength of the power according to the variation value of the equivalent resistance of the sensing coil may be stored in the memory, and the controller 500 may determine the material of the container and drive the heating coil 142 with the strength of the power corresponding to the determined material of the container. In addition, the controller 500 may turn on or display the UI for heating the container with an appropriate power strength based on the material of the container on the control panel 130 such that the user recognizes the UI.

A home appliance according to an embodiment of the present disclosure may include a top plate on which a container may be seated; a plurality of heating coils for heating the container using electromagnetic induction; a plurality of sensing coils electromagnetically coupled to the container to generate equivalent resistance and equivalent inductance when the container may be seated on the top plate; and a plurality of container sensing sensors configured to detect at least one of a position, a size, and a material of the container seated on the top plate, based on an oscillation signal according to change in the equivalent resistance of the plurality of sensing coils.

In accordance with one embodiment, each of the container sensing sensors may include an oscillation circuit having adjustable capacitance, wherein each of the container sensing sensors may be configured to detect at least one of a position, a size, and a material of the container based on the oscillation signal resonating at an oscillation frequency determined based on an inductance of the sensing coil and the capacitance.

In accordance with one embodiment, the container sensing sensor may be configured to detect a ferromagnetic container using an oscillation signal resonating at a first oscillation frequency, and to detect a paramagnetic container using an oscillation signal resonating at a second oscillation frequency lower than the first oscillation frequency.

In accordance with one embodiment, the container sensing sensor may include: an oscillation circuit including at least one capacitor and configured to adjust a capacitance so that the oscillation frequency may be determined using the sensing coil and the at least one capacitor, and to generate the oscillation signal resonating at the oscillation frequency; an oscillation driving circuit including a driving switch, and configured to operate the driving switch such that oscillation energy may be stored in the sensing coil or the oscillation signal freely resonates according to the operation of the driving switch; and a sensing output circuit configured to filter a DC component from the oscillation signal, compare the filtered oscillation signal with a reference signal, and output a container sensing signal according to a result of the comparison to a controller.

In accordance with one embodiment, the home appliance may further include a controller configured to control operation of the container sensing sensor and determine the container information based on the container sensing signal received from the container sensing sensor.

In accordance with one embodiment, the container sensing sensor may be configured to detect the container using the oscillation signal attenuating by an attenuation amount varying due to the equivalent resistance varying based on a degree of electromagnetic coupling between the container and the sensing coil and a material of the container.

In accordance with one embodiment, the controller may be configured to determine at least one of a position, a size, and a material of the container based on the container sensing signal received from the container sensing sensor.

In accordance with one embodiment, the controller may be configured to selectively drive at least one heating coil among the plurality of heating coils based on a position of the container.

In accordance with one embodiment, the controller may be configured to adjust an intensity of power to be applied to the heating coil based on the material of the container.

In accordance with one embodiment, the oscillating circuit may include: a first oscillation capacitor connected in parallel to the sensing coil; a second oscillation capacitor connected in parallel to the first oscillation capacitor; and an adjustment switch configured to selectively connect the second oscillation capacitor and the first oscillation capacitor in a parallel manner to each other according to a switching operation thereof, thereby adjusting the capacitance.

In accordance with one embodiment, the controller may be configured to control an operation of the adjustment switch so that the container sensing sensor may detect the container using the oscillation signal resonating at at least two different oscillation frequencies.

In accordance with one embodiment, the oscillating circuit may be configured to generate the oscillation signal resonating at a first oscillation frequency determined based on an inductance of the sensing coil and a capacitance of the first oscillation capacitor when the adjustment switch may be turned off, wherein the oscillating circuit may be configured to generate the oscillation signal resonating at a second oscillation frequency determined based on the inductance of the sensing coil and a capacitance of a combination of the first oscillation capacitor and the second oscillation capacitor connected in parallel to each other when the adjustment switch may be turned on.

In accordance with one embodiment, the second oscillation frequency may be set to a value lower than the first oscillation frequency, wherein the oscillation signal resonating at the first oscillation frequency may be used to sense the container made of a first material, wherein the oscillation signal resonating at the second oscillation frequency may be used to sense the container made of a second material different from the first material. The first material may include a magnetic material or a ferromagnetic material, and the second material may be a non-magnetic material or a paramagnetic material.

In accordance with one embodiment, the container sensing sensor may periodically repeat a process of detecting the container using the oscillation signal resonating at the first oscillation frequency and the second oscillation frequency before induction heating and during induction heating.

In accordance with one embodiment, while at least one of the plurality of container sensing sensors detects the container using the oscillation signal freely resonating, each of the other container sensing sensors thereof may discharge energy charged in the sensing coil.

In accordance with one embodiment, at least two container sensing sensors among the plurality of container sensing sensors may be grouped into a single group and may be simultaneously driven.

In accordance with one embodiment, a plurality of heating coils and a plurality of sensing coils may be integrally formed with each other in the PCB pattern coil assembly.

In accordance with one embodiment, the PCB pattern coil assembly may be composed of a plurality of PCB layers, a sensing coil pattern may be formed in at least two of the plurality of PCB layers, and a heating coil pattern may be formed in another layer thereof in which the sensing coil pattern is not formed.

In accordance with one embodiment, the sensing coil may be formed in a coil pattern wound in a circular or polygonal shape.

In accordance with one embodiment, the patterns of the sensing coils formed in the at least two layers may be electrically connected to each other via a via.

In accordance with one embodiment, the PCB pattern coil assembly may be divided into a plurality of unit blocks, and one heating coil pattern composed of a plurality of layers may be disposed in each of the plurality of unit blocks.

According to an embodiment, at least two sensing coil patterns, each composed of at least two layers, may be disposed in each of the plurality of unit blocks so as to overlap the heating coil pattern.

According to an embodiment, at least two sensing coil patterns may be disposed between two unit blocks among the plurality of unit blocks so as to overlap the heating coil pattern of each unit block.

Although the present disclosure has been described above with reference to the embodiments illustrated in the drawings, this is merely an example, and those skilled in the art will understand that various modifications and other equivalent embodiments may be derived therefrom. Accordingly, the true technical protection scope of the present disclosure should be determined based on the following claims.

1. A home appliance comprising:
a top plate on which a container is seated;
a plurality of heating coils for heating the container using electromagnetic induction;
a plurality of sensing coils electromagnetically coupled to the container to generate equivalent resistance and equivalent inductance when the container is seated on the top plate; and
a plurality of container sensing sensors configured to detect at least one of a position, a size, and a material of the container seated on the top plate, based on an oscillation signal according to change in the equivalent resistance of the plurality of sensing coils.

2. The home appliance of claim 1, wherein each of the container sensing sensors includes an oscillation circuit having adjustable capacitance,
wherein each of the container sensing sensors is configured to detect at least one of a position, a size, and a material of the container based on the oscillation signal resonating at an oscillation frequency determined based on an inductance of the sensing coil and the capacitance.

3. The home appliance of claim 2, wherein the container sensing sensor is configured to detect a ferromagnetic container using an oscillation signal resonating at a first oscillation frequency, and to detect a paramagnetic container using an oscillation signal resonating at a second oscillation frequency lower than the first oscillation frequency.

4. The home appliance of claim 1, wherein the container sensing sensor includes:
an oscillation circuit including at least one capacitor and configured to adjust a capacitance so that the oscillation frequency is determined using the sensing coil and the at least one capacitor, and to generate the oscillation signal resonating at the oscillation frequency;
an oscillation driving circuit including a driving switch, and configured to operate the driving switch such that oscillation energy is stored in the sensing coil or the oscillation signal freely resonates according to the operation of the driving switch; and
a sensing output circuit configured to filter a DC component from the oscillation signal, compare the filtered oscillation signal with a reference signal, and output a container sensing signal according to a result of the comparison to a controller.

5. The home appliance of claim 4, wherein the home appliance further comprises a controller configured to control operation of the container sensing sensor based on the container sensing signal.

6. The home appliance of claim 5, wherein the container sensing sensor is configured to detect the container using the oscillation signal attenuating by an attenuation amount varying due to the equivalent resistance varying based on a degree of electromagnetic coupling between the container and the sensing coil and a material of the container.

7. The home appliance of claim 4, wherein the controller is configured to determine at least one of a position, a size, and a material of the container based on the container sensing signal received from the container sensing sensor.

8. The home appliance of claim 7, wherein the controller is configured to selectively drive at least one heating coil among the plurality of heating coils based on a position and a size of the container.

9. The home appliance of claim 7, wherein the controller is configured to adjust an intensity of power to be applied to the heating coil based on the material of the container.

10. The home appliance of claim 4, wherein the oscillating circuit includes:
a first oscillation capacitor connected in parallel to the sensing coil;
a second oscillation capacitor connected in parallel to the first oscillation capacitor; and
an adjustment switch configured to selectively connect the second oscillation capacitor and the first oscillation capacitor in a parallel manner to each other according to a switching operation thereof, thereby adjusting the capacitance.

11. The home appliance of claim 10, wherein the controller is configured to control an operation of the adjustment switch so that the container sensing sensor detects the container using the oscillation signal resonating at at least two different oscillation frequencies.

12. The home appliance of claim 10, wherein the oscillating circuit is configured to generate the oscillation signal resonating at a first oscillation frequency determined based on an inductance of the sensing coil and a capacitance of the first oscillation capacitor when the adjustment switch is turned off,
wherein the oscillating circuit is configured to generate the oscillation signal resonating at a second oscillation frequency determined based on the inductance of the sensing coil and a capacitance of a combination of the first oscillation capacitor and the second oscillation capacitor connected in parallel to each other when the adjustment switch is turned on.

13. The home appliance of claim 12, wherein the second oscillation frequency is set to a value lower than the first oscillation frequency,
wherein the oscillation signal resonating at the first oscillation frequency is used to sense the container made of a first material,
wherein the oscillation signal resonating at the second oscillation frequency is used to sense the container made of a second material different from the first material.

14. The home appliance of claim 13, wherein the container sensing sensor periodically repeats a process of detecting the container using the oscillation signal resonating at the first oscillation frequency and the second oscillation frequency before induction heating and during induction heating.

15. The home appliance of claim 1, wherein while at least one of the plurality of container sensing sensors detects the container using the oscillation signal freely resonating, each of the other container sensing sensors thereof discharges energy charged in the sensing coil,
wherein at least two container sensing sensors among the plurality of container sensing sensors are grouped into a single group and are simultaneously driven.
